(19) United States
(12) Patent Application Publication
(10) Pub. No.: US 2010/0235066 A1
(43) Pub. Date: Sep. 16, 2010

(54) SYSTEM AND METHOD FOR ENGINE LOAD MANAGEMENT

(76) Inventor: Stephen Francis Hill, Peoria, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/601,503

(22) PCT Filed: May 31, 2007
(86) PCT No.: PCT/US07/12803

§ 371 Date: May 25, 2010

(51) Int. Cl. F02D 43/00

(52) U.S. Cl. 701/102

(57) ABSTRACT

An engine load management system is disclosed. The engine load management system may have an engine and a hydraulic device driven by the engine. The engine load management system may also have a sensor associated with the hydraulic device to detect a load change of the hydraulic device, and a controller in communication with the engine, the hydraulic device, and the sensor. The controller may be configured to determine a change in engine operation required to accommodate the detected load change, and determine a modification of an engine parameter required to produce the change in engine operation. The controller may be further configured to determine a capacity for the modification, and implement the modification and relieve the load change from the hydraulic device before the load change is transmitted to the engine, based on the capacity for the modification.

### TECHNICAL FIELD

The present disclosure relates generally to a load management system and, more particularly, to a system and method for managing a predicted load on an engine.

### BACKGROUND

Machines such as, for example, loaders, excavators, dozers, motor graders, haul trucks, and other types of heavy equipment are often outfitted with an engine-driven pump that provides high pressure fluid used to accomplish a variety of tasks. In one example, a loader uses the high pressure fluid to move actuators associated with a bucket of the loader. In another example, a haul truck uses the high pressure fluid to drive wheels of the truck (i.e., the pump is packaged together with one or more motors in a hystat-transmission arrangement). For cost and efficiency reasons, the machine's engine may be too small to drive the pump and supply a maximum amount of pressurized fluid that could be demanded by an operator or operational situation at any given time. Thus, it may be possible for the fluid demands, if fully satisfied, to produce loads on the engine that are severe enough to cause engine “stalling” or “lugging”. That is, the amount of power required from the engine to drive the pump, as demanded by the operator or the particular operational situation, may exceed an immediate output capacity or a total output capacity of the engine, thereby causing excessive engine speed droop. “Lugging” or “stalling” the engine may decrease the productivity and efficiency of the engine.

One way to minimize undesirable engine speed droop may be to reduce the load applied to the engine when the engine has insufficient output capacity to accommodate the load. An example of this strategy is disclosed in U.S. Pat. No. 7,146,263 (the '263 patent) issued to Guven et al. on Dec. 5, 2006. Specifically, the '263 patent discloses a predictive load management system having a power source and a transmission operably engaged with the power source. A control system receives an input indicative of a load on the transmission, and identifies a desired load on the transmission based on the input. The control system also receives an input indicative of a current power output of the power source, and limits the desired transmission load applied to the engine based on the current power output. In this manner, the power source is prevented from operating outside of a desired operating range (i.e. prevented from excessively lugging or stalling).

Although the '263 patent may help to minimize the amount of undesired engine speed droop, it may facilitate slow response to transient loading. That is, by only reducing the transmission load applied to the engine in response to an immediate capacity of the engine, the engine may be insufficiently controlled to increase output and respond to an increasing load.

Another way to minimize undesirable engine speed droop may be to anticipate a change in load, and control the engine to accommodate the load before the load is applied to the engine. An example of this strategy is disclosed in U.S. Pat. No. 6,901,324 (the '324 patent) issued to Guven et al. on May 31, 2005. Specifically, the '324 patent discloses a predictive load management system having a power source and a transmission operably engaged with the power source. A control system receives an input indicative of a load on the transmission, and identifies a change in the load on the transmission based on the input. The control system also determines a desired power output of the power source to account for the change in the load on the transmission. The control system modifies a performance characteristic of the power source to cause the power source to generate the desired power output before the change in the load on the transmission is transmitted to the power source. In this manner, the power source may be prevented from operating outside of a desired operating range.

Although the '324 patent may help to minimize the amount of undesired engine speed droop, it may only be helpful when the current power output of the power source is less than a maximum power output. That is, if no further modifications of the performance characteristic can be made, the power source speed may still droop undesirably under the newly applied transmission load.

The present disclosure is directed towards overcoming one or more of the problems as set forth above.

### SUMMARY OF THE DISCLOSURE

One aspect of the present disclosure is directed to an engine load management system. The engine load management system may include an engine and a hydraulic device driven by the engine. The engine load management system may also include a sensor associated with the hydraulic device to detect a load change of the hydraulic device, and a controller in communication with the engine, the hydraulic device, and the sensor. The controller may be configured to determine a change in engine operation required to accommodate the detected load change, and determine a modification of an engine parameter required to produce the change in engine operation. The controller may be further configured to determine a capacity for the modification, and implement the modification and relieve the load change from the hydraulic device before the load change is transmitted to the engine, based on the capacity for the modification.

Another aspect of the present disclosure is directed to a method of managing a load on an engine. The method may include drawing power from the engine to generate a flow of fluid, and detecting a change in a flow characteristic of the fluid. The method may also include determining a change in engine operation required to accommodate effects of the detected flow characteristic change, and determining a modification of an engine parameter required to produce the change in engine operation. The method may further include determining a capacity for the modification, and implementing the modification and reducing the change in flow characteristic before the effects of the flow characteristic change are transmitted to the engine, based on the capacity for the modification.

### BRIEF DESCRIPTION OF THE DRAWINGS

FIG. 1 is a schematic and diagrammatic representation of an exemplary disclosed engine;

FIG. 2 is an exemplary disclosed engine map for use in controlling the engine of FIG. 1; and

FIG. 3 is an exemplary disclosed method of operating the engine of FIG. 1.

### DETAILED DESCRIPTION

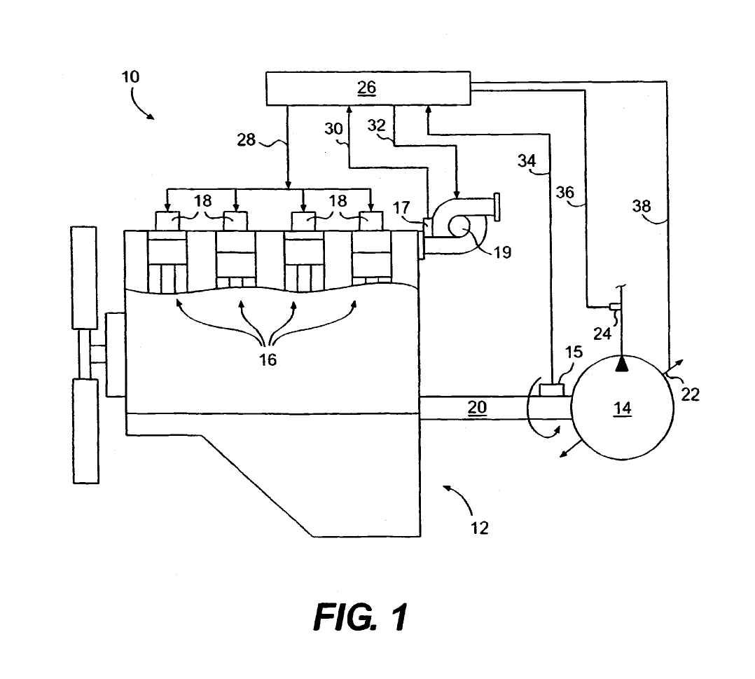

An exemplary embodiment of an engine load management system 10 is illustrated in FIG. 1. Engine load management system 10 may be used with, for example, an engine 12 and a hydraulic device 14 driven by engine 12. In this embodiment, engine 12 may be a turbo-aspirated diesel engine, gasoline engine, natural gas engine, or any other engine readily apparent to one skilled in the art. Engine 12 may alternatively be supercharged, naturally aspirated, or have any other type of air induction configuration.

Engine 12 may include a plurality of cylinders 16. A head assembly 18 having a fuel injector (not shown) and at least one engine valve (not shown) may be associated with each cylinder 16 to form a combustion chamber. In the illustrated embodiment, engine 12 may include four combustion chambers. One skilled in the art will readily recognize, however, that engine 12 may include a greater or lesser number of combustion chambers and that the combustion chambers may be disposed in an “in-line” configuration, a “V” configuration, or any other conventional configuration.

Engine 12 may have a desired operating range. For the purposes of this disclosure, the term “desired operating range” includes those speeds and torques at which engine 12 experiences substantially stable and efficient operation. When operating outside the desired operating range, engine 12 may experience unstable operation such as, for example, overspeed situations, underspeed situations, lugging, and/or stalling. Efficiency losses may also be experienced by engine 12 when operating outside the desired operating range such as, for example, increased fuel consumption, increased exhaust emissions, increased power source temperatures, and/or decreased responsiveness.

An input drive member such as, for example, a countershaft 20, may connect engine 12 to hydraulic device 14. As described in greater detail below, hydraulic device 14 may convert an input rotation of countershaft 20 into a flow of pressurized fluid. In this manner, power generated by engine 12 may be transmitted to the fluid and, in reverse direction, from the fluid to engine 12.

One or more sensors may be associated with engine 12 to provide relevant indications of the operation of engine 12. For example, a sensor 15 may be configured to sense engine speed and generate a speed signal in response thereto. Sensor 15 may be, for example, in the form of a magnetic pick-up sensor situated to produce a signal corresponding to the rotational speed of engine 12. Sensor 15 may also be capable of determining the speed, angular position, and/or rotational direction of countershaft 20. In addition, an intake sensor 17 may be operable to sense a pressure of charged air leaving a compressor 19 and entering the combustion chambers of engine 12, and to generate an appropriate intake air pressure signal.

Hydraulic device 14 may be a pump associated with a hystat-transmission, a work tool actuator circuit, or any other circuit requiring variable flows and/or pressures of fluid to support operation thereof. Hydraulic device 14 may be a variable displacement device having a displacement control element 22. In one example, hydraulic device 14 may be a swashplate-type pump, wherein an actual displacement of hydraulic device 14 is varied by changing a tilt angle of an associated swashplate. In another example, hydraulic device 14 may be a piston-type pump, wherein an effective displacement of hydraulic device 14 is varied by changing a ratio of fluid discharged to a high pressure circuit (not shown) and fluid spilled to a low pressure reservoir (not shown).

The position of displacement control element 22 and, thus the displacement of hydraulic device 14, may be related to an amount of power required from engine 12 (i.e., an amount of power absorbed by hydraulic device 14 from engine 12). Specifically, for a given pressure, a larger flow rate of fluid (i.e., a larger displacement per stroke with a substantially constant number of strokes per minute, a substantially constant displacement with an increased number of strokes per minute, or both a larger displacement per stroke with an increased number of strokes per minute) requires more power from engine 12. Similarly, for a given flow rate of fluid, a higher pressure requires more power from engine 12. Thus, when hydraulic device 14 is operating at a constant speed and a fixed displacement setting, and an external load is placed on the fluid discharged from hydraulic device 14 (i.e., when the pressure and/or flow rate of the fluid suddenly and/or unexpectedly increases), more power will be required and absorbed from engine 12. If the increased load is not accommodated by engine 12, engine 12 may lug or even stall under the change in load. Similarly, when hydraulic device 14 is operating at a constant speed and a fixed displacement setting, and an external load is removed from the fluid discharged from hydraulic device 14 (i.e., the pressure and/or flow rate of the fluid suddenly and/or unexpectedly decreases), less power will be required from engine 12. If the drop in load is not accommodated by engine 12, engine 12 may exceed the desired operating range and, possibly, overspeed.

One or more sensors may be associated with hydraulic device 14 to detect a change in the load placed on hydraulic device 14 (i.e., to detect a change in the load placed on the fluid discharged from hydraulic device 14) and externally-induced by, for example, varying terrain or payload. For example, a sensor 24 may be situated to generate a signal indicative of a change in pressure and/or a flow rate of fluid being discharged from hydraulic device 14.

Engine load management system 10 may include a controller 26 embodied in a single microprocessor or multiple microprocessors that include a means for controlling operations of engine 12 and hydraulic device 14. Numerous commercially available microprocessors can be configured to perform the functions of controller 26. Various other known circuits may be associated with controller 26, including power supply circuitry, signal-conditioning circuitry, solenoid driver circuitry, communication circuitry, and other appropriate circuitry.

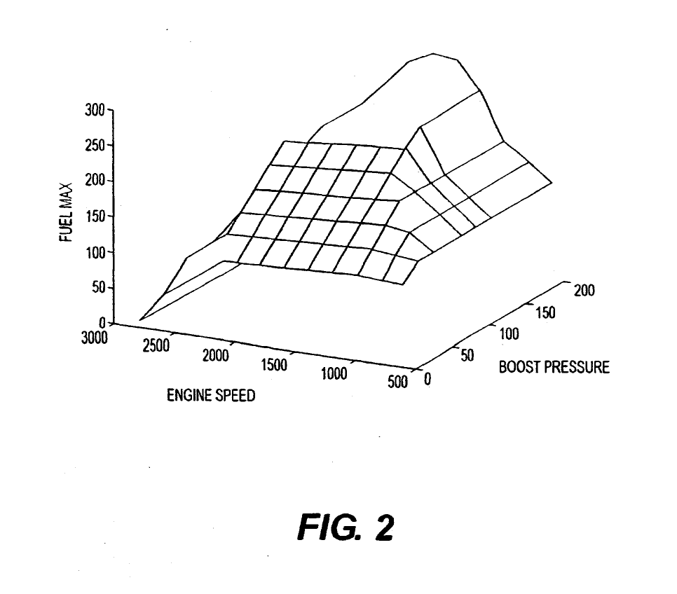

Controller 26 may include one or more maps stored within an internal memory, and may reference these maps to determine a necessary change in engine operation, a modification of an engine parameter required to affect the required change in engine operation, a capacity of engine 12 for the modification, and/or an amount of load relief required to minimize engine lug or overspeed for various hydraulic loading conditions. Each of these maps may include a collection of data in the form of tables, graphs, and/or equations. One example of such a map is illustrated in FIG. 2. In this map, a current engine speed, as measured by sensor 15, together with a current boost pressure, as measured by sensor 17, may be referenced by controller 26 to determine an associated maximum fuel setting. This maximum fuel setting may correspond with a government regulated exhaust emission limit, a predetermined loss in engine efficiency, a threshold of stable engine operation, or another similar limit or threshold. When this maximum fuel setting is exceeded, a resulting air-to-fuel ratio may cause engine 12 to be non-compliant with the regulated limit, the efficiency of engine 12 to be unacceptable, and/or the operation of engine 12 to be erratic or unstable.

Controller 26 may be in communication with the components of engine load management system 10 (referring to FIG. 1). Specifically, controller 26 may be in communication with the fuel injector and/or engine valves of head assemblies 18 via a communication line 28, with sensor 17 via a communication line 30, with compressor 19 via a communication line 32, with sensor 15 via a communication line 34, with sensor 24 via a communication line 36, and with displacement control element 22 via a communication line 38. In response to input from sensors 15, 17, and 24, controller 26 may relieve a changing load on hydraulic device 14 and/or modify an operating parameter of engine 12 to accommodate the changing load during a predictive time period when the change in load is being transferred from hydraulic device 14 to engine 12.

The predictive time period, for the purposes of this disclosure, is the period of time from when sensor 24 first detects a change in load on hydraulic device 14, until engine 12 actually experiences the load change. For example, sensor 24 will identify a sudden increase in pressure of the fluid exiting hydraulic device 14. Hydraulic device 14 will then begin absorbing a greater amount of torque from engine 12 via countershaft 20, and engine performance will be changed to accommodate the new power demand. The time associated with this load transfer is the predictive time period.

Controller 26 may adjust the performance of engine 12 when the received input (i.e., the input received from sensor 24) indicates that the load on hydraulic device 14 has changed. That is, in response to a sudden and/or unexpected increase or decrease in the pressure and/or flow rate of fluid exiting hydraulic device 14, controller 26 may produce parameter altering signals to increase or decrease the power output of engine 12. These parameter altering signals may be sent to engine 12, during the predictive time period.

Controller 26 may direct the parameter altering signals to the fuel injectors within head assemblies 18 to adjust the engine's air-to-fuel ratio such that a change in the power output of engine 12 is achieved. For example, in response to a sudden and/or unexpected increase in fluid pressure and/or flow rate from hydraulic device 14, controller 26 may communicate a command to the fuel injectors to increase an amount of injected fuel, to advance a fuel injection timing, to increase a pressure of the injected fuel, to consolidate a number of injection shots during a single injection event, or to change any other similar fueling parameter that results in the production of more power. In similar fashion, in response to a sudden decrease in pressure, controller 26 may communicate to the fuel injectors a command for less fuel, a command for retarded fuel injection, a command for lower fuel pressures, a command for more dispersed injection events, or commands for other fuel related changes that result in the production of less power. These signals may be sent during the predictive time period such that the operation of engine 12 remains within the desired operating range when the change in load is experienced by engine 12.

The fuel delivery altering signals may be produced based on a differential between a desired engine output required to meet a load change and the current engine output. In the exemplary engine load management system 10, fuel delivery to engine 12 may be changed during the predictive time period to bring the actual engine output to the desired engine output in preparation for responding to the anticipated change in load demand. As a result, the fuel delivery parameters may be changed based on the perceived power output required to reduce speed droop or overspeed associated with the coming change in load, while still preventing power source failure.

The fuel delivery altering signals may also be produced in accordance with the engine control maps discussed above. That is, in some situations, the fuel delivery change required to accommodate the coming change in load may actually exceed the fuel limit contained with in the air-to-fuel ratio limit map. In these situations, only a portion of the fuel delivery change may be implemented (i.e., the maximum allowable amount may implemented instead of the fuel delivery amount required to accommodate the load change).

When the full fuel delivery change is prevented or only partially implemented, other precautions must be take in order to minimize engine lug and/or the likelihood of engine stalling. These other precautions may include minimizing the amount of load that is transferred from hydraulic device 14 to engine 12 (i.e., relieving some of the load change from hydraulic device 14). Controller 26 may regulate an amount of hydraulic device load relief based on a comparison of an actual air-to-fuel ratio to the air-to-fuel ratio limit (or based on an actual fuel setting and a fuel setting limit for a given engine speed and inlet air boost pressure). In one example, the load relief may be a step-function, wherein the load is limited to the current load at the time the actual air-to-fuel ratio reaches the air-to-fuel ratio limit. In another example, the amount of load relief may be inversely related to the difference between the actual air-to-fuel ratio and the air-to-fuel ratio limit (i.e., as the air-to-fuel ratio limit is approached, a greater amount of load relief is implemented). In yet another example, the amount of load relief may be affected by the rate at which the air-to-fuel ratio limit is being approached (i.e., for a higher rate of ratio change, a higher amount of load relief is implemented). Other load relief strategies may also be possible.

Load relief of hydraulic device 14 may be achieved by changing a displacement thereof (i.e., changing a setting of displacement control element 22). For example, for a given number of strokes per minute and a given or suddenly increased pressure, the power or power increase required of engine 12 may be reduced by decreasing a displacement of hydraulic device 14. It is contemplated that load relief may be implemented in ways other than stroke displacement, if desired. Among others, these alternative methods may include using a load relief valve associated with an output of hydraulic device 14 to selective dump fluid to a low pressure reservoir (i.e., reduce a pressure of the fluid discharged from hydraulic device 14), operating a clutch mechanism that is disposed between engine 12 and hydraulic device 14 to selectively interrupt the transmission of power, or other ways known in the art.

It is contemplated that both fuel delivery changes and load relief may be simultaneously implemented, if desired. In particular, controller 26 may determine that engine 12 has some capacity for fuel delivery modification, but not enough capacity to fully accommodate the coming load change. In this situation, controller 26 may determine an amount of load relief that must occur in order to prevent operation of engine 12 from deviating from the desired operating range. Controller 26 may then implement the available fuel delivery modification substantially simultaneously with the appropriate amount of load relief.

It is also contemplated that air delivery characteristics of engine 12 may be altered to increase the air-to-fuel ratio limit and, thus, the capacity of engine 12 to prepare for a coming load. These air delivery characteristics may include a boost pressure of the intake air, and or an air delivery rate or amount. The boost pressure and/or delivery rate may be increased by, for example, changing an operational characteristic of compressor 19 (i.e., changing a blade orientation of a variable geometry compressor, changing a nozzle ring setting, changing a wastegate setting, changing a compressor bypass setting, increasing a driving speed of compressor 19, etc.). The air delivery rate and/or amount may also be modified by varying an opening and/or closing time of the engine valves located within head assemblies 18.

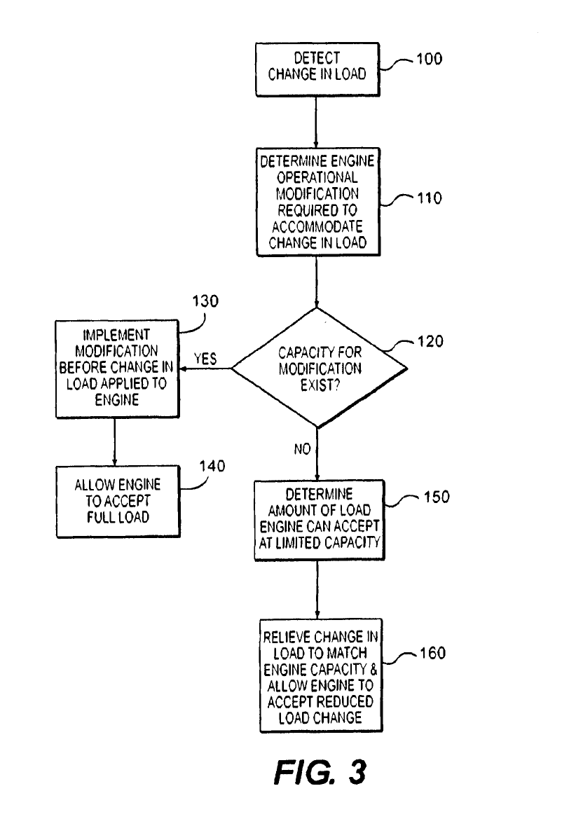

A flow chart illustrating an exemplary method of operating engine load management system 10 is shown in FIG. 3. The flowchart will be discussed in the follow section to further illustrate engine load management system 10 and its operation.

### INDUSTRIAL APPLICABILITY

In conventional systems, the time required to transfer a desired change in load from a driven hydraulic device to an engine may result in the engine experiencing unstable operation. The system of the present disclosure, however, is configured to decrease the amount of time required to transfer the change in load to the engine and/or reduce the amount of load change experienced by the engine, thereby avoiding the unstable operation. The disclosed system decreases the transfer time and/or reduces the load change by preparing the engine in advance of the load transfer, determining an amount of load transfer that can be accommodated by the engine, and relieving the remaining amount of load change from the hydraulic device. In this manner, the system of the present disclosure operates in advance of the timing of a conventional system. The operation of engine load management system 10 will be now be explained with reference to FIG. 3.

Control of engine load management system 10 may begin when a change in the load on hydraulic device 14 has been detected (Step 100). As described above, the change in load may be manifest by way of a sudden and/or unexpected change (increase or decrease) in pressure and/or flow rate of fluid discharged from hydraulic device 14. This change in fluid flow characteristics may be observed by sensor 24, which may transmit a signal indicative of the change to controller 26 by way of communication line 36.

In response to the signal from sensor 24 indicating a change in loading of hydraulic device 14, controller 26 may determine an engine operational modification required to accommodate the change in load (Step 110). That is, controller 26 may determine what change to the fuelling and/or air induction parameters must be made during the predictive time period such that, when the full change in load is transmitted from hydraulic device 14 to engine 12, the operation of engine 12 remains within the desired operating range.

After determining the required modification, controller 26 may determine if engine 12 has sufficient capacity for the modification (Step 120). For example, controller 26 may determine, in step 110, that fuelling must be increased to a level that exceeds a preset fueling limit. If controller 26 determines that the engine 12 does have the capacity for the modification (Step 120:YES), controller 26 may implement the modification (Step 130) during the predictive time period (i.e., before or simultaneous with the full change in load being transmitted from hydraulic device 14 to engine 12) (Step 140). In this manner, engine 12 may be prepared (i.e. the speed and/or power output of engine 12 may be increased or decreased in anticipation) for the coming load change.

However, if, in step 120, controller 26 determines that engine 12 has insufficient capacity for the required modification (Step 120:NO), controller 26 may then determine what amount of the full load change engine 12 can accept under limited modification capacity, without the operation of engine 12 deviating from the desired operating range (Step 150). Controller 26 may then allow engine 12 to accept the reduced load change, while relieving hydraulic device 14 of the remaining amount (Step 160).

The disclosed engine load management system may increase the overall efficiency of any engine by allowing the engine to operate a greater percent of the time within a desired operating range. Specifically, by determining a capacity for the engine to alter its operation and accept a change in loading, and relieving any excess load, the disclosed engine load management system may minimize the likelihood of engine under or over loading.

Other embodiments of the disclosed load management system will be apparent to those skilled in the art from consideration of the specification and practice of the system disclosed herein. It is intended that the specification and examples be considered as exemplary only, with a true scope being indicated by the following claims.

What is claimed is:

1. An engine load management system comprising:
an engine;
a hydraulic device driven by the engine;
a sensor associated with the hydraulic device to detect a load change of the hydraulic device; and
a controller in communication with the engine, the hydraulic device, and the sensor, the controller being configured to:
determine a change in engine operation required to accommodate the detected load change;
determine a modification of an engine parameter required to produce the change in engine operation;
determine a capacity for the modification; and
implement the modification and relieve the load change from the hydraulic device before the load change is transmitted to the engine, based on the capacity for the modification.

2. The engine load management system of claim 1, wherein the hydraulic device is a pump.

3. The engine load management system of claim 2, wherein the load change is relieved by varying a displacement of the pump.

4. The engine load management system of claim 1, wherein the change in engine operation is a change in output power.

5. The engine load management system of claim 1, wherein the engine parameter is an air-to-fuel ratio.

6. The engine load management system of claim 5, wherein the air-to-fuel ratio is changed by varying at least one of a fuel injection quantity, a fuel injection timing, a fuel injection pressure, and a number of fuel injection shots during a single fuel injection event.

7. The engine load management system of claim 5, wherein the air-to-fuel ratio is changed by varying at least one of an inlet air pressure, an intake air flow rate, and an engine valve timing.

8. The engine load management system of claim 5, wherein the controller determines a capacity for the modification by comparing a change in the air-to-fuel ratio required to accommodate the detected load change with an air-to-fuel ratio limit.

9. The engine load management system of claim 8, wherein the controller includes a map relating a speed of the engine and an inlet air pressure to the air-to-fuel ratio limit.

10. The engine load management system of claim 8, wherein the air-to-fuel ratio limit corresponds with a regulated exhaust emission limit.

11. The engine load management system of claim 8, wherein the air-to-fuel ratio limit corresponds with a predetermined loss in engine operational efficiency.

12. The engine load management system of claim 1, wherein the controller is configured to relieve the load change only when the capacity for the modification is insufficient.

13. The engine load management system of claim 5, wherein the controller is configured to substantially simultaneously implement a portion of the modification and relieve a portion of the load change when some capacity for modification exists, but the capacity is insufficient to produce the change in engine operation.

14. A method of managing a load on an engine, comprising:
drawing power from the engine to generate a flow of fluid;
detecting a change in a flow characteristic of the fluid;
determining a change in engine operation required to accommodate effects of the detected flow characteristic change;
determining a modification of an engine parameter required to produce the change in engine operation;
determining a capacity for the modification; and
implementing the modification and reducing the change in flow characteristic before the effects of the flow characteristic change are transmitted to the engine, based on the capacity for the modification.

15. The method of claim 14, wherein the change in engine operation is a change in output power.

16. The method of claim 14, wherein the engine parameter is an air-to-fuel ratio.

17. The method of claim 16, wherein the air-to-fuel ratio is changed by varying at least one of a fuel injection quantity, a fuel injection timing, a fuel injection pressure, and a number of fuel injection shots during a single fuel injection event.

18. The method of claim 16, wherein the air-to-fuel ratio is changed by varying at least one of an inlet air pressure, an intake air flow, rate, and an engine valve timing.

19. The method of claim 16, wherein the capacity for the modification is determined by comparing a change in the air-to-fuel ratio required to accommodate the detected load change with an air-to-fuel ratio limit.

20. The method of claim 19, wherein the air-to-fuel ratio limit corresponds with at least one of a regulated exhaust emission limit and a predetermined loss in engine operational efficiency.
